(19) United States
(12) Patent Application Publication
(10) Pub. No.: US 2007/0070628 A1
(43) Pub. Date: Mar. 29, 2007

(54) Street light with heat dispensing device

(76) Inventor: Chia-Yi Chen, Donggang Township (TW)

Correspondence Address: CHARLES E. BAXLEY, ESQ., 90 JOHN STREET, THIRD FLOOR, NEW YORK, NY, 10038, US

(21) Appl. No.: 11/605,875

(22) Filed: Nov. 29, 2006

Related U.S. Application Data
(63) Continuation-in-part of application No. 11/122,486, filed on May 4, 2005, now abandoned.

(51) Int. Cl. F21V 21/00

(52) U.S. Cl. 362/249

(57) ABSTRACT

A street light (1) includes a frame (11) with a plurality of integral fins extending from a top thereof and a plurality of Light Emitting Diodes (12) connected with a circuit board (121) are connected to underside of the frame. Two side boards (13) are connected to two ends of the frame and one of the side boards is connected with a post (132). A transparent cover (14) is connected to the underside of the frame by a plurality of clips (141) and at least one hinge (15) is connected to one of the side boards and the cover.

### FIELD OF THE INVENTION

The application is a Continuation-In-Part application of applicant's former patent application Ser. No. 11/122,486, filed on May 4, 2005.

### BACKGROUND OF THE INVENTION

A conventional street light generally includes a post and a frame is connected to the top end of the post, the frame includes a light bulb received therein and the light bulb lights up when being powered. However, the conventional light bulb consumes power energy so that the cost of electric power is huge. Besides, because the conventional light bulb requires a lot of electric power, it cannot be cooperated with solar power or battery packs.

Some street lights use Light Emitting diodes which save energy cost and occupy less space. Nevertheless, Light Emitting diodes generate high temperature of heat during operation and the heat affect the function of the Light Emitting diodes.

The present invention intends to provide a street light that uses Light Emitting diodes and a plurality of fins are located above the Light Emitting diodes so as to quickly release the heat. Besides, the Light Emitting diodes can be cooperated with solar power system or batteries.

### SUMMARY OF THE INVENTION

The present invention relates to a street light which comprises a frame and a plurality of fins integrally extend from a top of the frame. A circuit board is connected to an underside of the frame and a plurality of Light Emitting Diodes are connected with the circuit board. Two side boards are connected to two ends of the frame by bolts and one of the side boards is connected with a post. A transparent cover is connected to the underside of the frame by a plurality of clips. At least one hinge is connected to one of the side boards and the cover so that the cover can be pivoted away from the frame when in maintenance.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a first embodiment of the street light of the present invention;

FIG. 2 is a perspective view to show the street light of the present invention;

FIG. 3 is a cross sectional view of a second embodiment of the street light of the present invention;

FIG. 4 is a cross sectional view of a third embodiment of the street light of the present invention;

FIG. 5 is an exploded view to show a third embodiment of the street light of the present invention;

FIG. 6 is a perspective view of the third embodiment of the street light of the present invention;

FIG. 7 shows that a solar energy panel is cooperated with the street light of the present invention;

FIG. 8 is an exploded view to show a fourth embodiment of the street light of the present invention;

FIG. 9 shows a cross sectional view of the street light in FIG. 8;

FIG. 10 is a perspective view to show a fifth embodiment of the street light of the present invention;

FIG. 11 is a side cross sectional view of the street light in FIG. 10;

FIG. 12 shows that the Light Emitting Diodes are directly connected to the frame;

FIG. 13 shows that the fins are connected to the frame by bolts, and FIG. 14 shows the diagram of the parts of the circuit used in the street light of the present invention.

### DETAILED DESCRIPTION OF THE PREFERRED EMBODIMENT

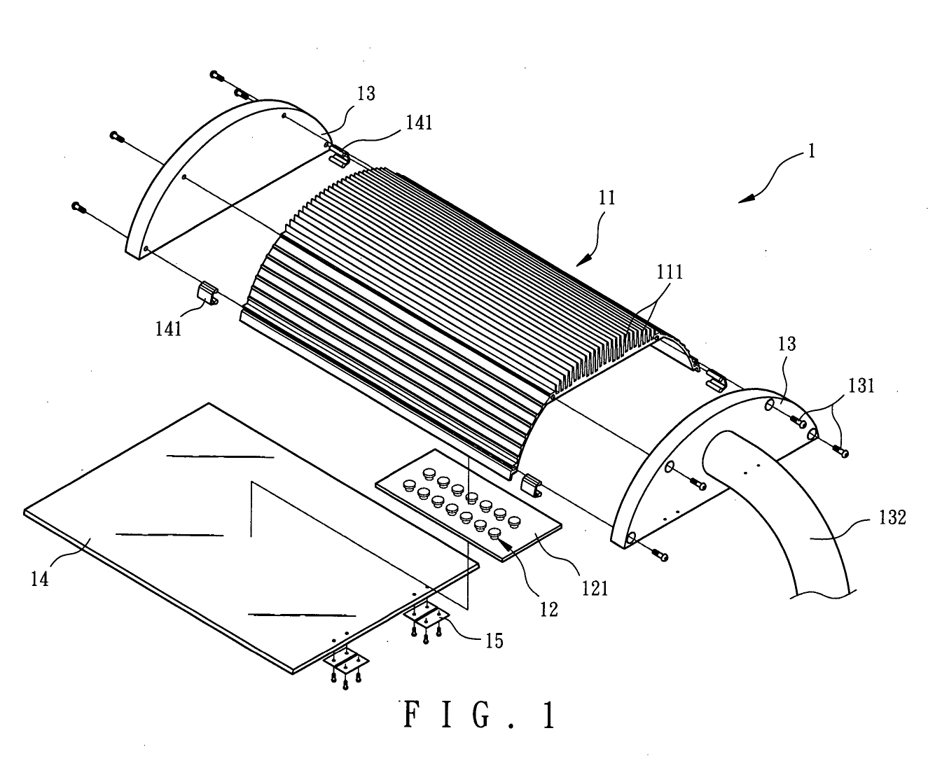

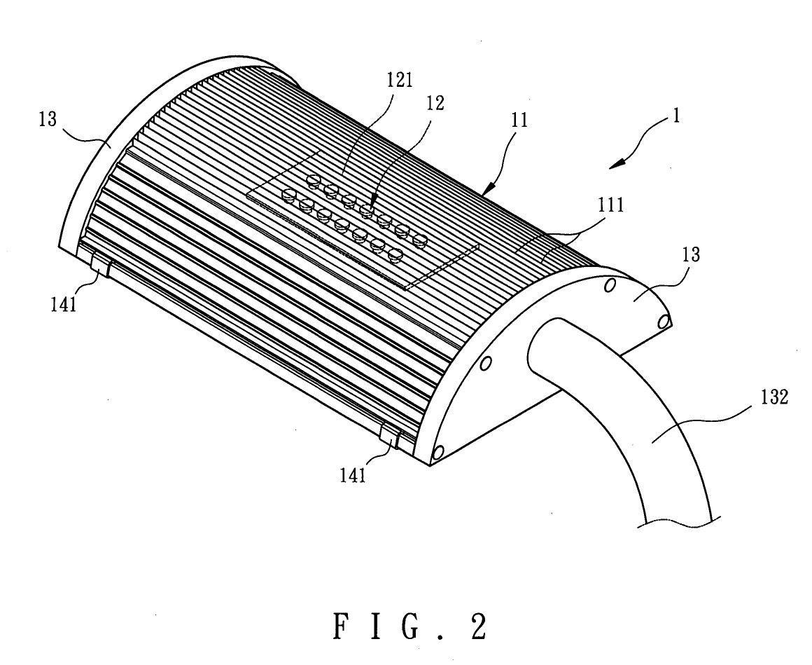

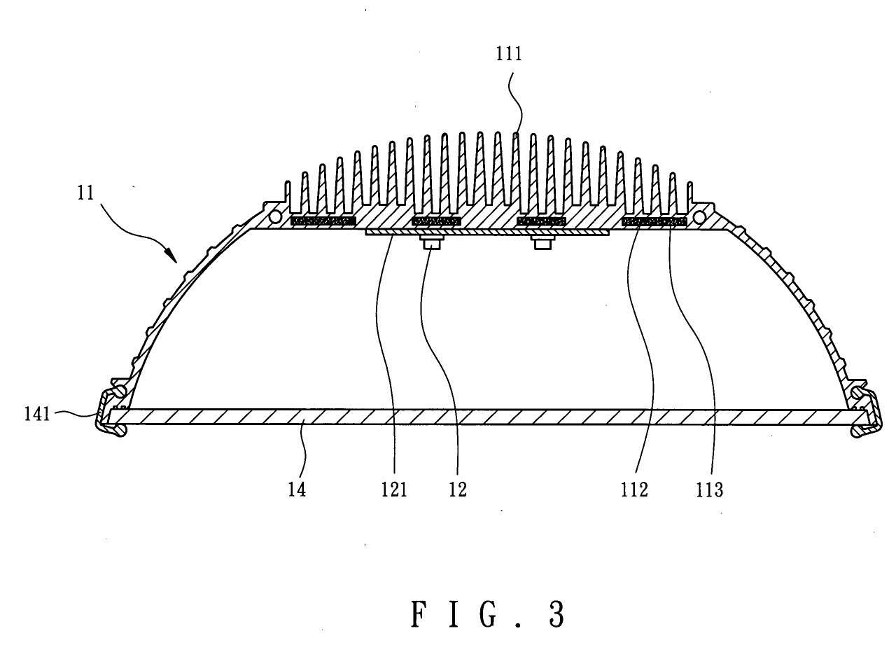

Referring to FIGS. 1 and 2, the street light 1 of the present invention comprises a frame 11 and a plurality of fins 111 integrally extend from a top of the frame 11. The frame 11 has an underside to which a circuit board 121 is connected and a plurality of Light Emitting Diodes 12 are connected to the circuit board 121. Two side boards 132 are connected to two ends of the frame 11 by bolts 131 and one of the side boards 132 is connected with the post 132 of the street light.

A transparent cover 14 is connected to the underside of the frame 11 by a plurality of clips 14 which clamp two sides of the cover 14 and the frame 11. The Light Emitting Diodes 12 and the circuit board 121 are located between the frame 11 and the cover 14. Two hinges 15 are connected to one of the side boards 13 and the cover 14 so that when the clips 141 are removed, the cover 14 can be pivoted away from the frame 11 when in maintenance.

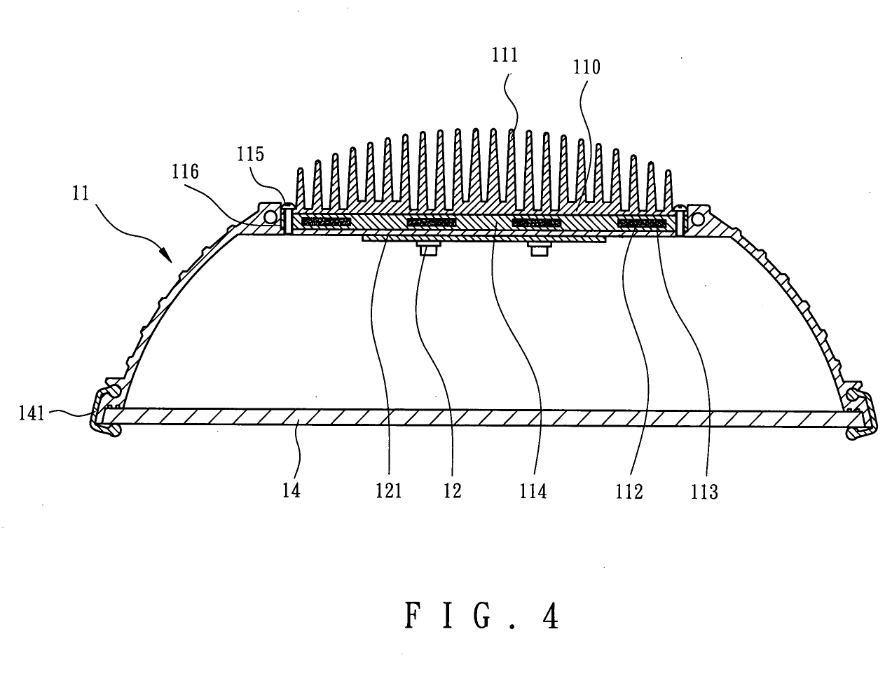

FIGS. 3 shows a second embodiment of the street light which includes a frame 11 and a plurality of fins 111 integrally extend from a top of the frame 11. The frame 11 has a plurality of enclosed chambers 112 and heat conductive material 113 is filled in the chambers 12. The heat conductive material 113 can be substance of high heat conductivity such as liquid alcohol or Nitrogen in gaseous form. A plurality of Light Emitting Diodes 12 are connected with a circuit board 121 which is connected to underside of the frame 11. Two side boards 132 are connected to two ends of the frame 11 by bolts 131 and one of the side boards 132 is connected with the post 132. A transparent cover 14 is connected to the underside of the frame 11 so that the Light Emitting Diodes 12 and the circuit board 121 are located between the frame 11 and the cover 14. A plurality of clips 141 connect the cover 14 to the frame 11. Two hinges 15 are connected to one of the side boards 13 and the cover 14. The heat conductive material can absorb the heat generated from the Light Emitting Diodes 22 and the heat is transferred to the atmosphere via the fins 211.

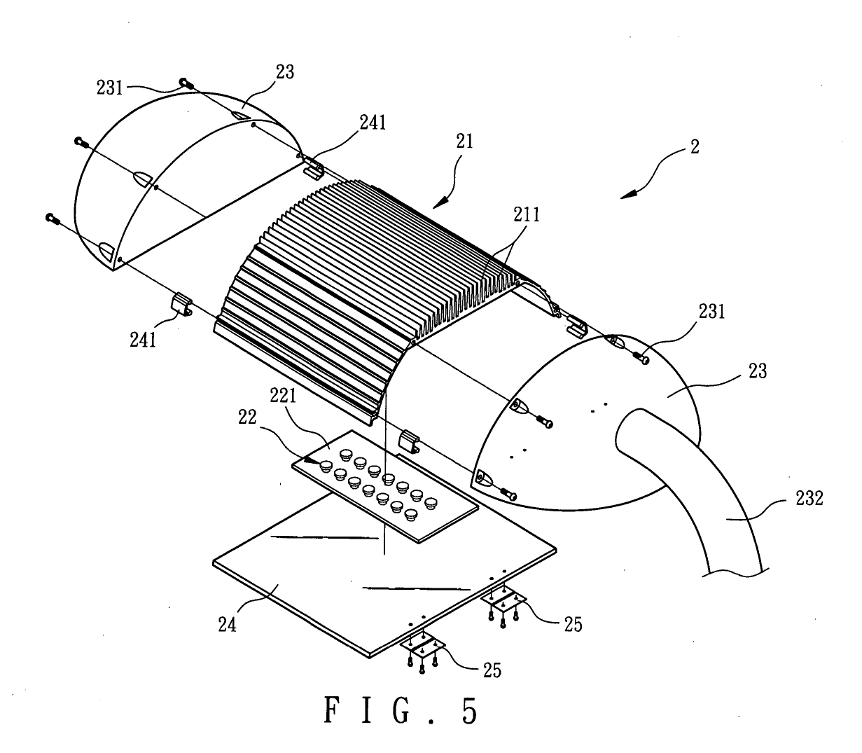

FIG. 4 shows another embodiment of the present invention wherein the frame 11 includes an engaging hole 116 defined in a top thereof and the fins 111 are integrally formed with a base board 110 which is connected to the inner periphery of the engaging hole 116 of the frame 11 by bolts 115. An intermediate member 114 is connected between the circuit board 121 and the frame 11. The intermediate member 114 includes a plurality of enclosed chambers 112 in which the heat conductive material 113 is filled which can be liquid alcohol or Nitrogen in gaseous form such that the heat conductivity of the frame 11 is improved and the heat generated from the Light Emitting Diodes 12 is quickly released.

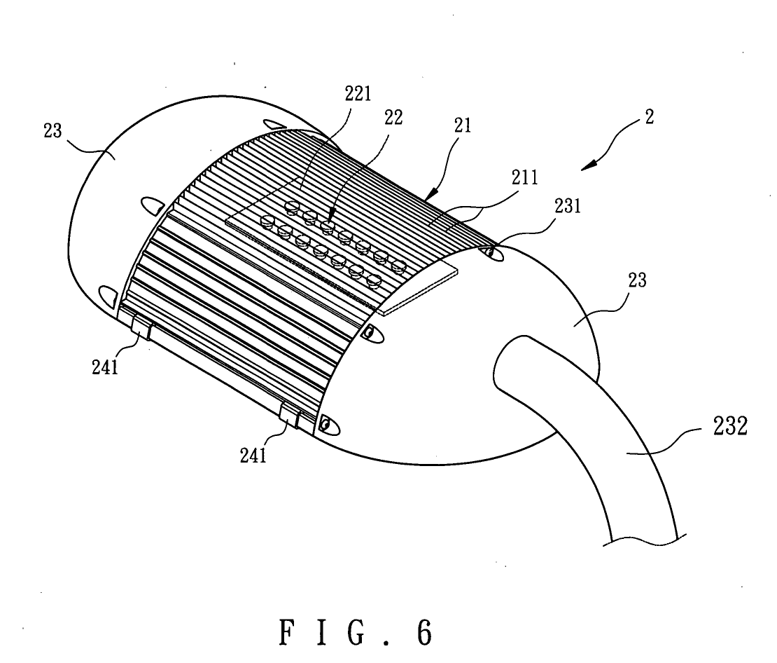

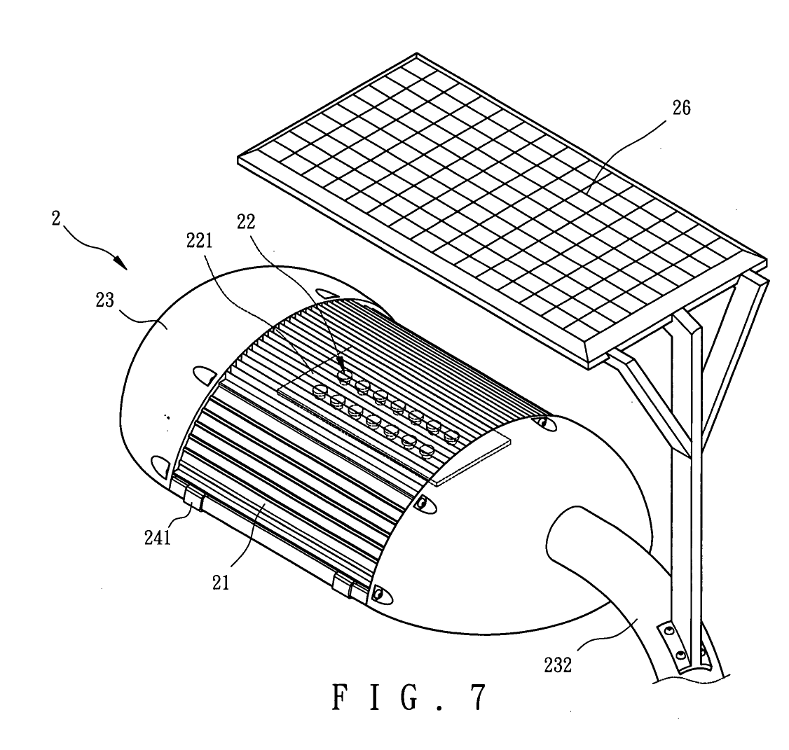

FIGS. 5 and 6 show a third embodiment of the street light which includes a frame 21 with a plurality of fins 211 integrally extending from a top of the frame 11. A plurality of Light Emitting Diodes 22 are connected with a circuit board 221 which is connected to underside of the frame 21. Two curved cup-like side members 232 are connected to two ends of the frame 11 by bolts 231 and one of the side members 232 is connected with the post 232. A transparent cover 24 is connected to the underside of the frame 21 so that the Light Emitting Diodes 22 and the circuit board 221 are located between the frame 21 and the cover 24. A plurality of clips 241 connect the cover 24 to the frame 21. Two hinges 25 are connected to one of the side members 23 and the cover 24. As shown in FIG. 7, a solar energy panel 26 is located above the frame 21 so as to provide the power for the Light Emitting Diodes 22. The solar energy panel can also be replaced by a battery unit which is not shown.

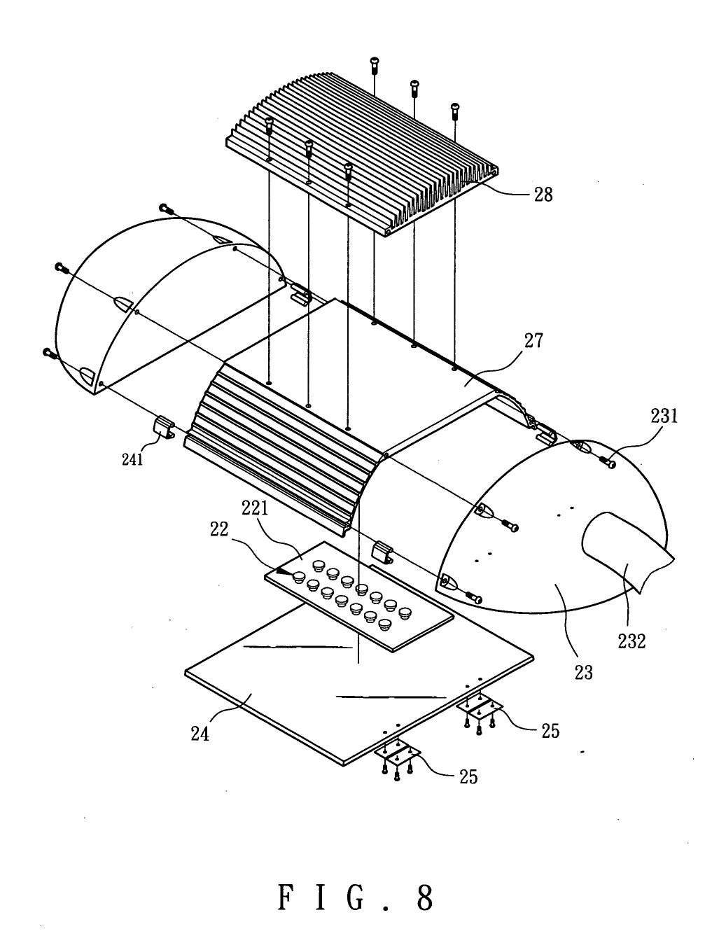

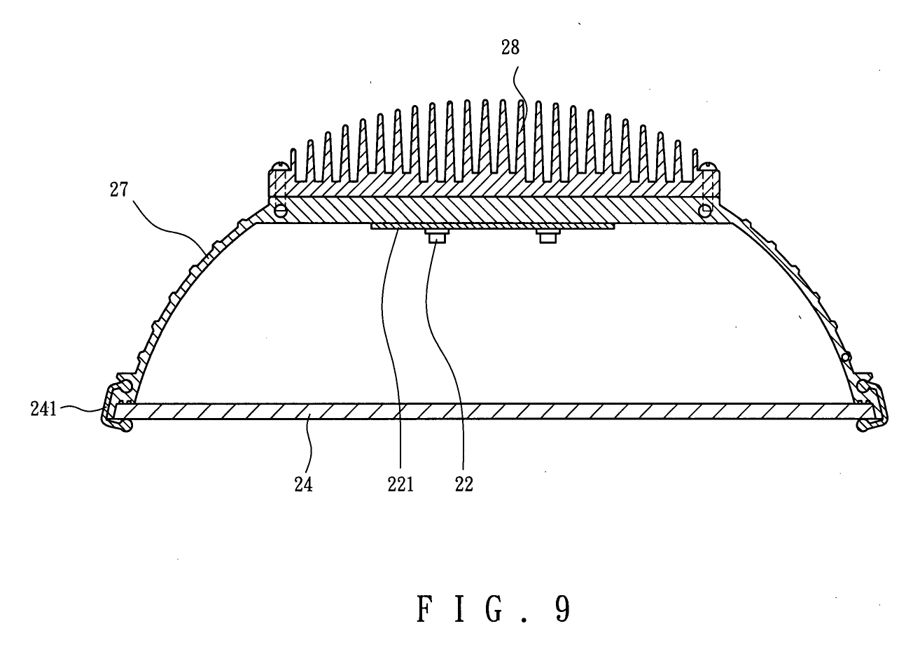

FIGS. 8 and 9 show a fourth embodiment of the street light wherein the street light includes a frame 27 and a plurality of fins 28 are connected to a top of the frame 27 by bolts. A plurality of Light Emitting Diodes 22 are connected with a circuit board 221 which is connected to underside of the frame 27. Two curved cup-like side members 23 are connected to two ends of the frame 27 by bolts 231 and one of the side members 23 is connected with the post 232. A transparent cover 24 is connected to the underside of the frame 27 so that the Light Emitting Diodes 22 and the circuit board 221 are located between the frame 27 and the cover 24. A plurality of clips 241 connect the cover 24 to the frame 27. Two hinges 25 are connected to one of the side members 13 and the cover 24.

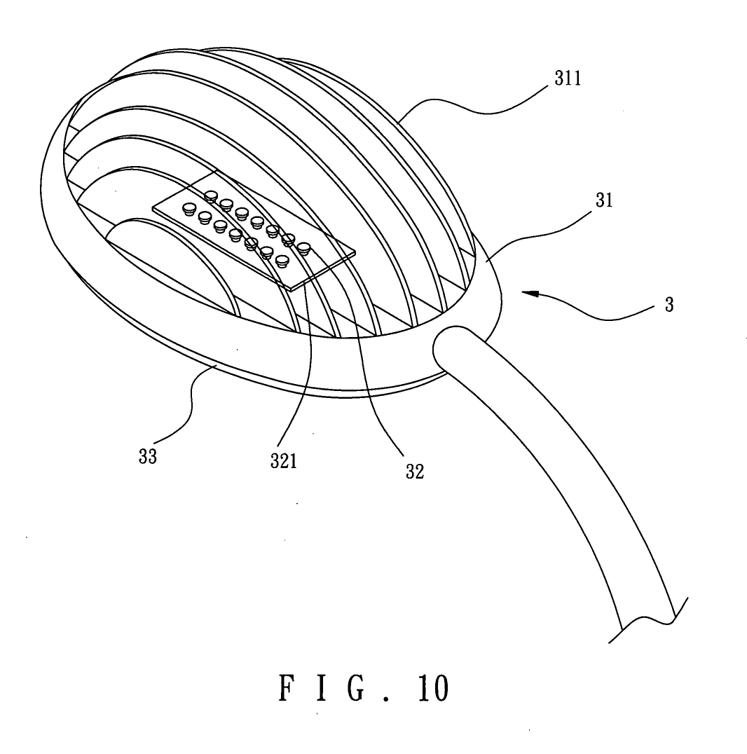

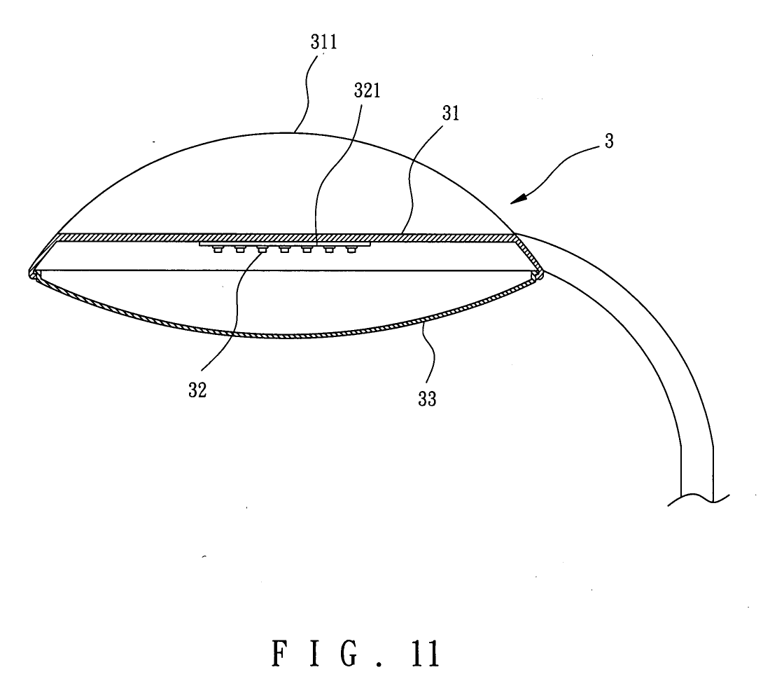

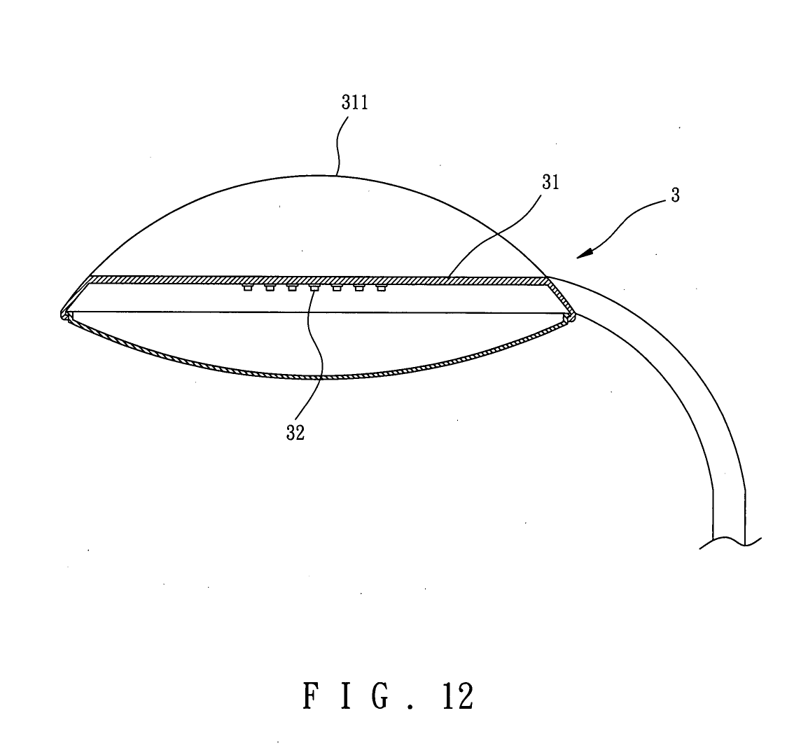

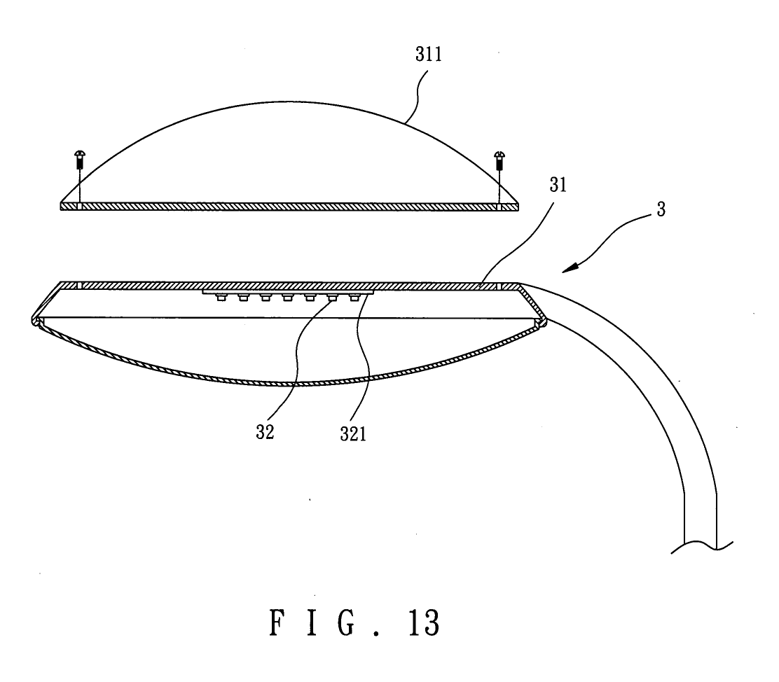

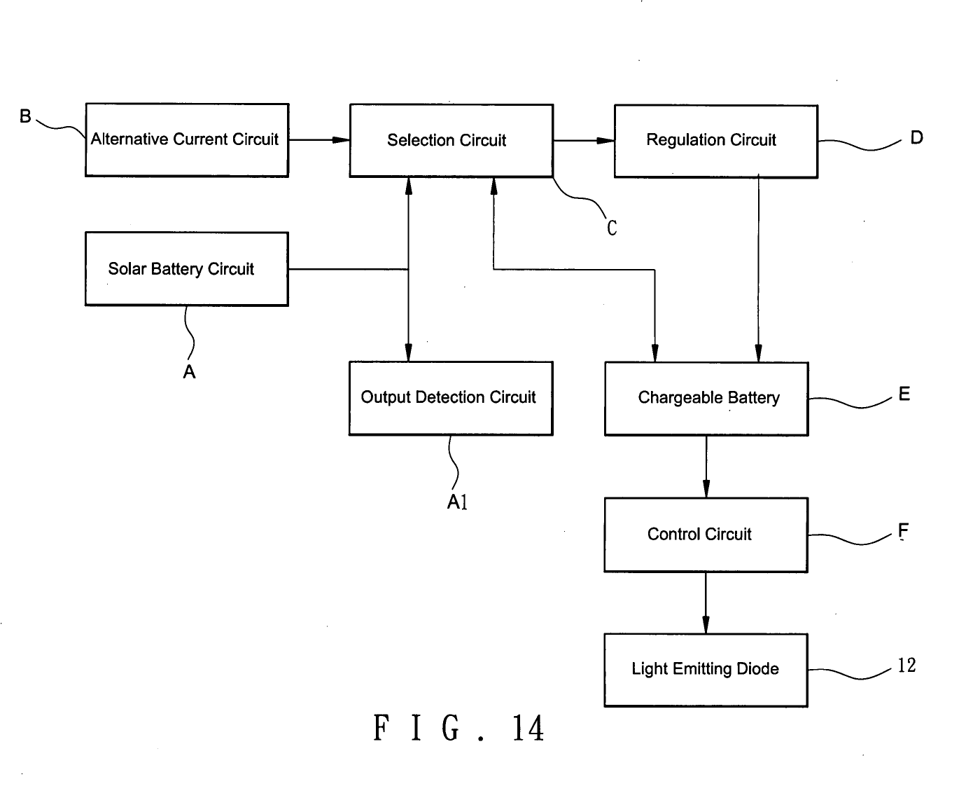

FIGS. 10 and 11 show a fifth embodiment of the street light of the present invention wherein the street light 3 comprises a frame 31 and a plurality of fins 311 integrally extend from a top of the frame 31. The frame 31 and the fins 311 can be made by casting. A plurality of Light Emitting Diodes 32 are connected with a circuit board 321 which is connected to underside of the frame 31. A transparent cover 33 is connected to the underside of the frame 31 so that the Light Emitting Diodes 32 and the circuit board 321 located between the frame 31 and the cover 34. As shown in FIG. 12, the Light Emitting Diodes 32 can also be directly connected to the frame 31. FIG. 13 shows that the fins 311 can be connected to the frame by bolts.

FIG. 14 discloses the diagram of the parts of the circuit used in the street light wherein the circuit includes a solar battery circuit “A” which has an output detection circuit “A1”, an Alternative Current circuit “B”, a selection circuit “C” for selecting the power source, a regulation circuit “D”, a chargeable battery “E” and a control circuit “F”. The control circuit “F” is connected with at least one Light Emitting Diode 32.

In day time, the solar battery circuit “A” provides a high voltage which is split by the output detection circuit “A1” and the control circuit “F” cuts off the power of the Light Emitting Diode 32 so as to save energy. The relay of the selection circuit “C” is activated to charge the chargeable battery “E” by the output of the solar battery circuit “A” via the selection circuit “C” and the regulation circuit “D”. In night time, the solar battery circuit “A” cannot provide a sufficient voltage so that the output detection circuit “A1” detects and connects the control circuit “F” and the Light Emitting Diode 32 which is powered by the chargeable battery “E”. When the chargeable battery “E” runs out, the control circuit “F” connects the Light Emitting Diode 32 with the Alternative Current circuit “B”.

While we have shown and described the embodiment in accordance with the present invention, it should be clear to those skilled in the art that further embodiments may be made without departing from the scope of the present invention.

What is claimed is:

1. A street light comprising:
a frame and a plurality of fins extending from a top of the frame;
a plurality of Light Emitting Diodes connected with a circuit board which is connected to underside of the frame;
two side boards connected to two ends of the frame by bolts and one of the side boards connected with a post;
a transparent cover connected to the underside of the frame so that the Light Emitting Diodes and the circuit board located between the frame and the cover, a plurality of clips connecting the cover to the frame, and
at least one hinge connected to one of the side boards and the cover.

2. The street light as claimed in claim 1, wherein the fins are integrally connected with the frame.

3. The street light as claimed in claim 1, wherein the fins extend from a base board which is connected to the frame by bolts.

4. A street light comprising:
a frame and a plurality of fins extending from a top of the frame, the frame having a plurality of enclosed chambers and heat conductive material being filled in the chambers;
a plurality of Light Emitting Diodes connected with a circuit board which is connected to underside of the frame;
two side boards connected to two ends of the frame by bolts and one of the side boards connected with a post;
a transparent cover connected to the underside of the frame so that the Light Emitting Diodes and the circuit board located between the frame and the cover, a plurality of clips connecting the cover to the frame, and
at least one hinge connected to one of the side boards and the cover.

5. The street light as claimed in claim 4, wherein the heat conductive material is liquid alcohol or Nitrogen in gaseous form.

6. The street light as claimed in claim 4, wherein the fins integrally extend from the frame.

7. The street light as claimed in claim 4, wherein the fins extend from a base board which is connected to the frame by bolts.

8. The street light as claimed in claim 4, wherein an intermediate member is connected to the frame and the enclosed chambers are defined in the intermediate member.

9. A street light comprising:
a frame and a plurality of fins extending from a top of the frame;
a plurality of Light Emitting Diodes connected with a circuit board which is connected to underside of the frame;
two curved cup-like side members connected to two ends of the frame by bolts and one of the side members connected with a post;
a transparent cover connected to the underside of the frame so that the Light Emitting Diodes and the circuit board located between the frame and the cover, a plurality of clips connecting the cover to the frame, and
at least one hinge connected to one of the side members and the cover.

10. The street light as claimed in claim 9, wherein a solar energy panel is located above the frame.

11. The street light as claimed in claim 9, wherein the fins are integrally connected with the frame.

12. The street light as claimed in claim 9, wherein the fins extend from a base board which is connected to the frame by bolts.

13. A street light comprising:
a frame and a plurality of fins extending from a top of the frame;
a plurality of Light Emitting Diodes connected to the frame, and
a transparent cover connected to the underside of the frame so that the Light Emitting Diodes and the circuit board located between the frame and the cover.

14. The street light as claimed in claim 13, wherein the fins are integrally connected with the frame.

15. The street light as claimed in claim 13, wherein the fins extend from a base board which is connected to the frame by bolts.

16. The street light as claimed in claim 13, wherein an intermediate member is connected to the frame and includes a plurality of enclosed chambers in which heat conductive material is filled.

17. The device as claimed in claim 16, wherein the heat conductive material is liquid alcohol or Nitrogen in gaseous form.
